(19) United States
(12) Patent Application Publication
(10) Pub. No.: US 2013/0161058 A1
(43) Pub. Date: Jun. 27, 2013

(54) CABLE WITH NON-FLAMMABLE BARRIER LAYER

(71) Applicant: GENERAL CABLE TECHNOLOGIES CORPORATION, Highland Heights, KY (US)

(72) Inventors: David P. CAMP, II, Florence, KY (US); Scott M. BROWN, Independence, KY (US); David M. FAUSZ, Fort Thomas, KY (US); James D. MALKEMUS, Union, KY (US)

(73) Assignee: GENERAL CABLE TECHNOLOGIES CORPORATION, Highland Heights, KY (US)

(21) Appl. No.: 13/717,016

(22) Filed: Dec. 17, 2012

Related U.S. Application Data
(60) Provisional application No. 61/578,614, filed on Dec. 21, 2011.

(51) Int. Cl. H01B 7/295

(52) U.S. Cl. CPC H01B 7/295
USPC 174/102 R

(57) ABSTRACT

A cable that comprises a core that has at least one conductor, a dielectric barrier layer that surrounds the core, and a conductive shield that surrounds the core. The dielectric barrier layer is formed of a substantially non-flammable material and is devoid of fluoropolymers.

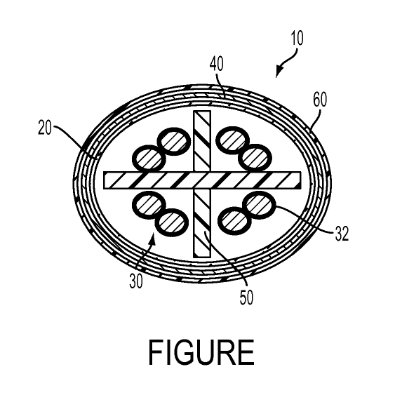

### RELATED APPLICATION

This application claims priority under 35 U.S.C. §119 to U.S. Provisional Application No. 61/578,614, filed on Dec. 21, 2011. This application may relate to commonly owned currently pending U.S. application Ser. No. 13/707,077, filed on Dec. 6, 2012, entitled Cable With Non-Flammable Component, the subject matter of which is herein incorporated by reference.

### FIELD OF THE INVENTION

The present invention relates to a cable having a barrier layer formed of a substantially non-flammable material. More specifically, the barrier layer of non-flammable material is provided between the shield and core of the cable.

### BACKGROUND OF THE INVENTION

Conventional communication cables for both riser and plenum applications typically include a number of insulated conductors that are bundled together or twisted together into pairs and surrounded by an outer jacket. Crosstalk or interference often occurs because of electromagnetic coupling between the conductors within the cable or other components in the cable, thereby degrading the cable's electrical performance.

Barriers are often used, particularly in plenum applications, to isolate the pairs of conductors, thereby reducing interference. Such barriers are normally made of polyester (PET) or fluoropolymers like FEP to meet industry standards, such as the requirements of NFPA 262 in the case of plenum cables. However, materials like polyester typically emit too much smoke which limits the amount of separation from the shielding. Flouropolymers like FEP tend to drip in the burn chamber. When these materials drip and hit the floor of the burn chamber, they smoke. Such smoke is undesirable, particularly in the plenum applications, and makes it more difficult to meet the industry requirements. Moreover, fluoropolymers are typically halogenated and release toxic halogens when burned. Also, fluoropolymers are typically more expensive due to material costs and high demand.

Therefore, a need exists for a cable barrier that meets industry standard burn requirements and that is less toxic, melts less, and is less expensive.

### SUMMARY OF THE INVENTION

Accordingly, the present invention provides a cable that comprises a core that has at least one conductor, a dielectric barrier layer that surrounds the core, and a conductive shield that surrounds the core. The dielectric barrier layer is formed of a substantially non-flammable material and is devoid of fluoropolymers.

The present invention may also provide a cable that comprises a core that includes a plurality of twisted pairs of conductors and a separator that separates the plurality of twisted pairs of conductors. A dielectric barrier layer surrounds the core and is formed of a substantially non-flammable, low smoke, zero halogen material and is devoid of fluoropolymers. A conductive shield surrounds the dielectric barrier layer and an outer jacket surrounds the conductive shield.

Other objects, advantages and salient features of the invention will become apparent from the following detailed description, which, taken in conjunction with the annexed drawing, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying Figure which is a cross-sectional view of a cable according to an exemplary embodiment of the invention.

### DETAILED DESCRIPTION OF THE INVENTION

Referring to the Figure, the present invention relates to a cable 10 that has an improved electrical performance because it incorporates a substantially non-flammable barrier layer 20. The barrier layer 20 surrounds a core 30 of conductors 32 of the cable 10 and separates the core 30 from a conductive shield 40 of the cable. The conductors 32 may be twisted into pairs and separated by a separator component 50, as seen in the Figure. The separator component 50 may be formed with any shape which accomplishes the desired separation properties. The shield 40 may be any conventional shield layer either continuously conductive or a discontinuous layer comprised of conductive segments. An outer jacket 60 may surround the core 20, barrier layer 30 and the shield 40. The outer jacket 60 may be formed of any conventional insulation, such as PVC.

The barrier layer 20 is preferably formed of a material that is substantially non-flammable, and more preferably a material that is low-smoke and zero halogen (LSZH) to reduce the toxicity of the cable when burned. Zero halogen means the material is non-halogenated and/or total ppm of accidental trace halogens as defined by applicable industry standards for zero halogen materials.

Exemplary non-flammable materials of the barrier layer 20 include fiberglass, individual glass fibers bunched together, fiberglass yarns, fiberglass strands, fiberglass rovings, chopped fiberglass, woven fiberglass tapes or sheets, and the like. Those materials are desirable because they have optimal burn properties while also allowing the barrier layer to maintain flexibility. Other suitable non-flammable materials can also be employed, such as basalt fibers, yarns, woven tapes, high temperature ceramic oxide fibers, yarns and woven tapes, other ceramic mica tapes, and the like. Those materials are desirable because of their high temperature performance in cable applications. The barrier layer 20 may be coated with a flame retardant material, that is preferably LSZH, to further aid the burn performance of the barrier layer 20 and the cable 10.

Additionally, the barrier layer 20 is preferably substantially devoid of any fluoroploymers, thereby significantly reducing material in the barrier layer that drips and smokes in the burn chamber. That improves the smoke performance in the plenum cable burn testing, for example, per NFPA 262.

The present invention allows for the cable core 30 to be separated from the shield 40 by a non-flammable barrier layer, such as an inorganic fiberglass tape for example, that has a suitable dielectric constant. That helps improve the attenuation performance of the cable 10 by providing spacing between the twisted pairs of conductors 32 in the core 30 and the shield 40 as well as providing a dielectric barrier between the core 30 and the shield 40. In addition, the present invention also aids in improving the burn and smoke performance of the cable by removing fluoropolymers from the cable construction which drip and smoke compared to the fiberglass material which will not melt or drip. Furthermore, halogenated materials are preferably removed from the cable which reduces the toxicity of the cable.

While a particular embodiment has been chosen to illustrate the invention, it will be understood by those skilled in the art that various changes and modifications can be made therein without departing from the scope of the invention as defined in the appended claims.

What is claimed is:

1. A cable, comprising:
a core having at least one conductor;
a dielectric barrier layer surrounding said core, said dielectric barrier layer being formed of a substantially non-flammable material and said dielectric barrier layer being devoid of fluoropolymers; and
a conductive shield surrounding said dielectric barrier layer.

2. A cable according to claim 1, wherein
said substantially non-flammable material is both a low smoke and zero halogen material.

3. A cable according to claim 1, wherein
said core includes a plurality of twisted insulated conductor pairs.

4. A cable according to claim 1, further comprising
a separator separating said plurality of twisted insulated conductor pairs, said dielectric barrier layer surrounding said separator.

5. A cable according to claim 1, wherein
said dielectric barrier layer is a tape.

6. A cable according to claim 5, wherein
said tape is formed of fiberglass.

7. A cable according to claim 6, wherein
said fiberglass is woven or chopped.

8. A cable according to claim 1, wherein
said dielectric barrier layer includes a coating of a flame retardant material.

9. A cable according to claim 8, wherein
said coating is formed of a low smoke zero halogen material.

10. A cable according to claim 1, further comprising
an outer jacket that surrounds said conductive shield.

11. A cable, comprising:
a core including a plurality of twisted pairs of conductors and a separator separating said plurality of twisted pairs of conductors;
a dielectric barrier layer surrounding said core, said dielectric barrier layer being formed of a substantially non-flammable, low smoke, zero halogen material and said dielectric barrier layer being devoid of fluoropolymers;
a conductive shield surrounding said dielectric barrier layer; and
an outer jacket surrounding said conductive shield.

12. A cable according to claim 11, wherein
said substantially non-flammable, low smoke, zero halogen material is one of fiberglass, individual glass fibers bunched together, fiberglass yarns, fiberglass rovings, chopped fiberglass, woven fiberglass tapes, basalt fibers, yarns, woven tapes, high temperature ceramic oxide fibers, yarns, woven tapes, and ceramic mica tapes.

13. A cable according to claim 11, wherein
said substantially non-flammable, low smoke, zero halogen material is fiberglass that is stranded, woven or chopped.

14. A cable according to claim 11, wherein
said dielectric barrier layer includes a coating of a flame retardant material.

15. A cable according to claim 14, wherein
said coating is formed of a low smoke zero halogen material.
